(19) United States
(12) Patent Application Publication
(10) Pub. No.: US 2019/0128720 A1
(43) Pub. Date: May 2, 2019

(54) AN APPARATUS AND A METHOD FOR DETERMINING A MEASUREMENT ERROR OF A DISPLACEMENT VOLUMETRIC METER, A METER MONITORING DEVICE, AND A METER MEASUREMENT ERROR DETERMINING DEVICE

(71) Applicant: Canetis Metering Limited, Surrey (GB)

(72) Inventor: Christopher Charles Farrell, Surrey (GB)

(21) Appl. No.: 16/093,834

(22) PCT Filed: Apr. 13, 2017
(86) PCT No.: PCT/GB2017/051036

§ 371 Date: Oct. 15, 2018

(30) Foreign Application Priority Data
Apr. 15, 2016 (GB) 1606661.5

(51) Int. Cl. G01F 3/22; G01F 15/06; G01D 4/00

(52) U.S. Cl. CPC G01F 3/227; G01F 3/226; G01D 4/002; G01F 15/065; G01F 3/221

(57) ABSTRACT

Apparatus for determining a measurement error of a displacement volumetric meter, the meter having bellows which in use expand and contract to transmit a fluid. The apparatus including a transducer operable to detect movement of the bellows and to generate a signal which varies in accordance with the movement of the bellows; and a computing device in communication with the transducer so as to receive the signal therefrom, the computing device being operable to determine a flow rate of fluid through the meter based on the signal, and to determine a measurement error of the meter based on the determined flow rate. A corresponding method, meter monitoring device and meter measurement error determining device are also disclosed.

### TECHNICAL FIELD

Various embodiments relate to an apparatus and a method for determining a measurement error of a displacement volumetric meter, the meter having bellows which in use expand and contract to transmit a fluid. Specific embodiments relate to determining a measurement error of the meter by determining a flow rate of fluid transmitted by the meter.

### BACKGROUND

It is known to utilise displacement volumetric meters to transmit and meter a fluid, for example, fuel gases such as natural gas or propane. Such meters are often used to provide a supply of fuel gas to a building, such as a house. The supply of gas may be used to power a hot water and/or heating system of the building.

A displacement volumetric meter contains two or more bellows. Fluid flow through the meter is directed by internal valves so that the bellows alternately fill and expel gas, producing a near continuous flow of fluid through the meter. As the bellows expand and contract, a counting mechanism uses the motion of the bellows to keep a record of how many times a fixed volume of the meter is swept to transmit the fluid. In this way, the counting mechanism provides a measure of how much fluid is transmitted by the meter.

Where the meter is used to transmit and meter fuel gas, a gas supplier, such as a gas utility company, charges a gas consumer, such as a building owner, based on a quantity of energy consumed. Gas consumption is determined based on readings taken from the meter. Gas consumption is converted into energy consumption for billing purposes.

Therefore, there is a continuing need to ensure that gas consumption measurement inaccuracies by the meter are identified. Also, there is a continuing need to ensure that conversion inaccuracies when converting from gas consumption to energy consumption are identified. In this way, occurrences of overcharging and undercharging can be reduced, and gas consumption is more predictable.

### SUMMARY OF EMBODIMENTS

A first aspect of the disclosure provides an apparatus for determining a measurement error of a displacement volumetric meter, the meter having bellows which in use expand and contract to transmit a fluid, the apparatus comprising: a transducer operable to detect movement of the bellows and to generate a signal which varies in accordance with the movement of the bellows; and a computing device in communication with the transducer so as to receive the signal therefrom, the computing device being operable to determine a flow rate of fluid through the meter based on the signal, and to determine a measurement error of the meter based on the determined flow rate.

A second aspect of the disclosure provides a method of determining a measurement error of a displacement volumetric meter, the meter having bellows which in use expand and contract to transmit a fluid, the method comprising: detecting movement of the bellows of the meter; determining a flow rate of fluid through the meter based on the movement of the bellows; and determining a measurement error of the meter based on the determined flow rate.

A third aspect of the disclosure provides a meter monitoring device for a displacement volumetric meter, the meter having bellows which in use expand and contract to transmit a fluid, the device comprising: a transducer operable to detect movement of the bellows and to generate a signal which varies in accordance with the movement of the bellows; and a transmitter in communication with the transducer so as to receive the signal therefrom, the transmitter being operable to transmit the signal.

A fourth aspect of the disclosure provides a meter measurement error determining device for a displacement volumetric meter, the meter having bellows which in use expand and contract to transmit a fluid, the device comprising: at least one processor and at least one memory containing computer executable code which when executed by the at least one processor causes the device to perform the following method: receive a signal which varies in accordance with movement of the bellows of the meter; determine a flow rate of fluid through the meter based on the received signal; and determine a measurement error of the meter based on the determined flow rate.

Various further features of the above-described aspects are set out in the appended claims.

### DESCRIPTION OF DRAWINGS

Embodiments of the disclosure will now be described with reference to the accompanying drawings, wherein like reference signs relate to like components, and in which:

FIG. 1 is a schematic diagram of an example environment within which an embodiment may operate;

FIG. 2 is a cross section diagram of an example displacement volumetric meter;

FIG. 3 is a graphical representation of an error of indication (EOI) of a displacement volumetric meter, wherein a percentage measurement error of the meter is plotted against a flow rate (m³/h) of fluid transmitted by the meter;

FIG. 4 is a schematic diagram of an apparatus for determining a measurement error of a displacement volumetric meter, in accordance with an embodiment;

FIG. 5 is a schematic diagram of an apparatus for determining a measurement error of a displacement volumetric meter, in accordance with an another embodiment;

FIG. 6 is a schematic diagram of a meter unit of an apparatus for determining a measurement error of a displacement volumetric meter, in accordance with a further embodiment;

FIGS. 7 to 9 are graphical representations of vibrations generated by example meters when transmitting fluid, wherein these representations include time-domain and frequency-domain representations;

FIG. 10 is a flow diagram of a method of determining a measurement error of a displacement volumetric meter, in accordance with an embodiment; and

FIG. 11 is a flow diagram of a method of determining a measurement error of a displacement volumetric meter, in accordance with another embodiment.

### DETAILED DESCRIPTION

Various embodiments relate to an apparatus and a method for determining a measurement error of a displacement volumetric meter, the meter having bellows which in use expand and contract to transmit a fluid.

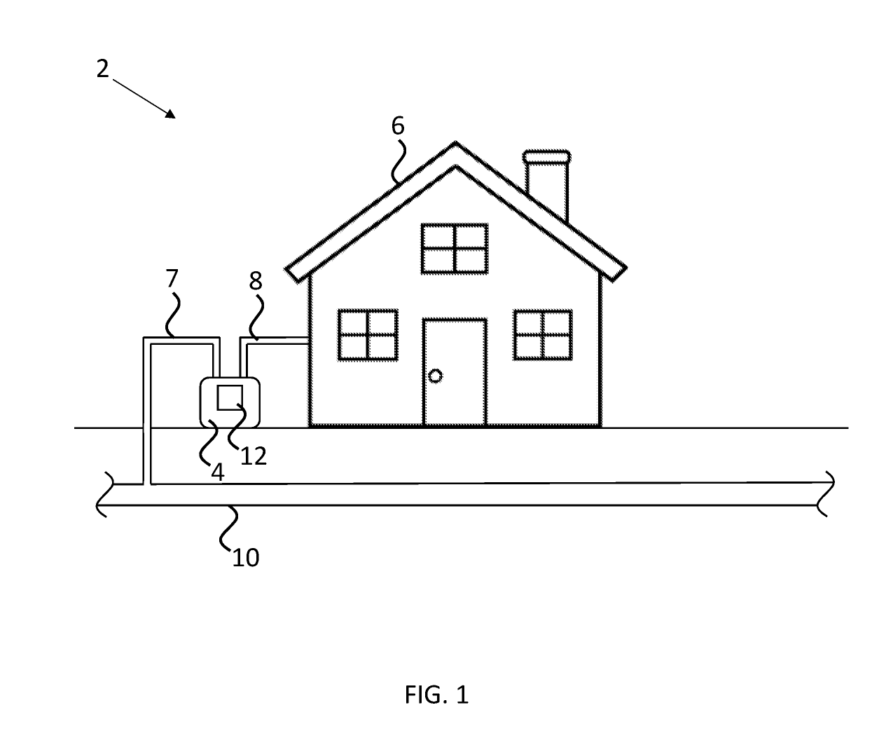

FIG. 1 illustrates an example environment 2 within which an embodiment may operate. FIG. 1 shows a displacement volumetric meter 4 in the form of a gas meter which measures a quantity of fuel gas (e.g. propane, natural gas and/or methane) entering a building 6. It is to be understood that in some other embodiments, a meter which transmits a fluid other than fuel gas may be used, such as, for example, a meter which transmits a liquid, such as, water.

The meter 4 has an inlet coupled to an inlet gas pipe 7 and an outlet coupled to an outlet gas pipe 8. The inlet pipe 6 branches off from a subterranean gas supply pipe 10. The pipe 10 is part of a gas distribution network which transports gas between different geographical locations. In use, the meter 4 transmits gas from the inlet gas pipe 7 to the outlet gas pipe 8 in order to provide gas to the building 6. Additionally, the meter 4 measures a volume of gas which is transmitted. Accordingly, a gas utility company can use the meter 4 to determine a quantity of gas which is used to fuel various systems (e.g. a heating system or a hot water system) in the building 6. In this way, the utility company can determine how much money to charge owners of the building 6 for the building's gas consumption. In FIG. 1, the building is a domestic house, but it is to be understood that in different embodiments, the building 6 may be any other type of building, for example, a commercial office or an industrial factory. Also, the meter 4 is shown positioned on the ground, outside and near to the building; however, it is to be understood that other positions are possible in different embodiments. For example, the meter 4 may be inside the building, above or below ground level, or in a designated structure.

In an embodiment, an apparatus 12 for determining a measurement error of the meter 4 is positioned on an outer surface of the meter 4. In an embodiment, the meter 4 has a metallic outer housing and the apparatus 12 includes meter attachment means including one or more magnets. In this way, the apparatus 12 is fixed to the meter 4 by magnetic attraction. Alternatively, the meter attachment means may include one or more straps which strap the apparatus 12 to the meter 4. Alternatively, the apparatus 12 may be mechanically fixed to the meter 4 in another manner, for example, via an adhesive.

The following explains the operation of the meter 4 in more detail, following which is provided an explanation of why certain measurements of the meter 4 contain a measurement error. Afterwards, the structure and operation of the apparatus 12 is described in accordance with various embodiments.

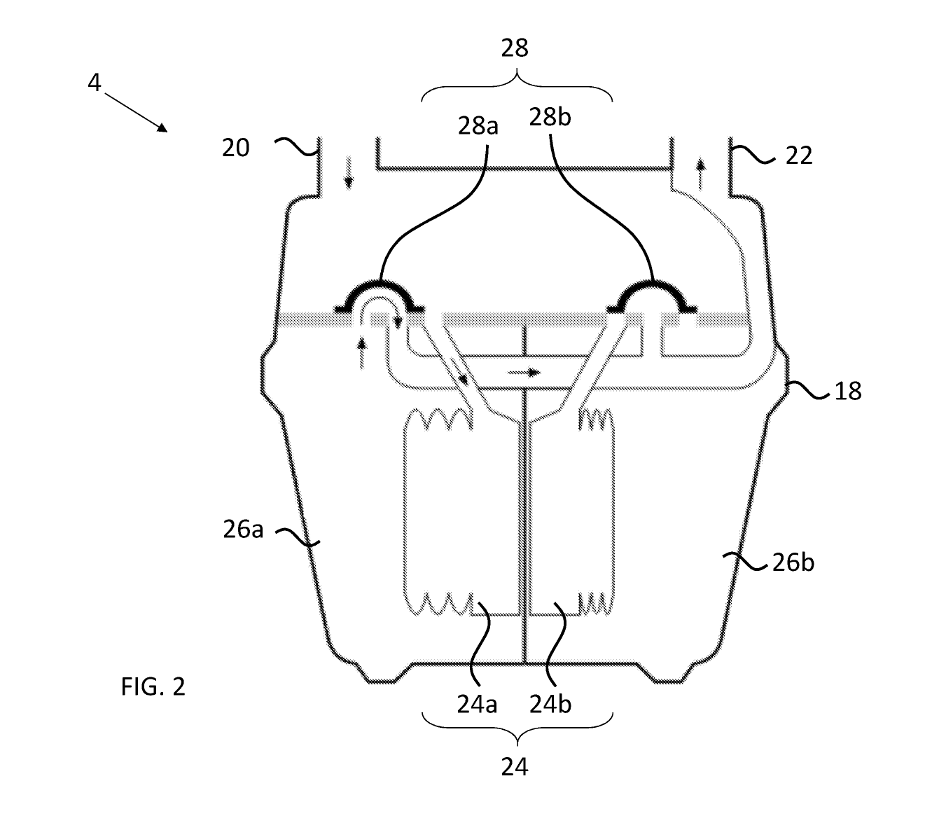

FIG. 2 illustrates a cross section view of the meter 4. The meter 4 includes a housing 18, an inlet 20 and an outlet 22. The housing 18 may be metallic. The inlet 20 is coupled to the gas inlet pipe 7 whereas the outlet 22 is coupled to the gas outlet pipe 8. The meter 4 contains bellows 24 including a left bellow 24a and a right bellow 24b. The left bellow 24a is located within a left compartment 26a of the meter 4. The right bellow 24b is located within a right compartment 26b of the meter 4. The meter 4 also includes a sliding value 28 having a left sliding portion 28a and a right sliding portion 28b. The left sliding portion 28a can move between three positions, in which: (i) the left compartment 26a is in communication with the outlet 22, and the left bellow 24a is in communication with the inlet 20 (as shown in FIG. 2); (ii) the left compartment 26a and the left bellow 24a are closed; and (iii) the left compartment 26a is in communication with the inlet 20, and the left bellow 24a is in communication with the outlet 22. The right sliding portion 28b can move in an analogous manner with respect to the right bellow 24b and the right compartment 26b.

In operation, the left sliding portion 28a and the right sliding portion 28b move in a cyclic sequence to cause the left bellow 24a and the right bellow 24b to alternately fill (i.e. expand) and expel (i.e. contract) gas, producing a near continuous gas flow through the meter 4. In this way, the bellows 24 move to transmit fluid. As the bellows 24 expand and contract, a metering mechanism (not shown) counts the number of times the bellows 24 expand and contract. In this way, the meter 4 meters the transmitted fluid. For example, levers (not shown) connected to cranks (not shown) convert the linear motion of the bellows 24 into rotary motion of a crank shaft (not shown). This crank shaft can drive an odometer-like counter mechanism (not shown) to record the number of times the bellows 24 expand and contract.

Since the volume of the meter 4 (e.g. the volume of the bellows 24 and compartments 26) is fixed, the amount of gas transferred by the meter 4 is a function of: the number of times the bellows 24 expand and contract, and the fixed volume of the meter 4. The number of times the bellows 24 expand and contract can be determined from the counter mechanism, and the fixed volume of the meter 4 is a constant. This constant could be determined empirically. In an embodiment, the meter 4 has a fixed volume of up to 160 m³.

It is to be understood that in some embodiments the meter includes more than two bellows. For example, the meter could include 4, 6, 8 or more bellows. In any case, the meter's sliding valve moves in a sequence to cause the bellows to alternately fill (i.e. expand) and expel (i.e. contract) gas, producing a near continuous gas flow through the meter.

The following provides an explanation of why certain measurements of displacement volumetric meters (e.g. meter 4) contain a measurement error, with reference to the gas supply industry of the United Kingdom (UK).

The UK has over 20 million installed gas meters that provide the metrology of gas consumption for domestic and non-domestic users. The majority of installed gas meters are mechanical volume displacement devices (i.e. displacement volumetric meters, like meter 4) that are subject to weights and measures legislation to ensure that they meet a prescribed level of accuracy. Gas meters may be installed for many decades and there are no mandatory individual checks to ensure that they maintain their designed accuracy. Therefore, over time, a meter may develop a meter drift or faults that generate errors in the metrological accuracy of the gas meter.

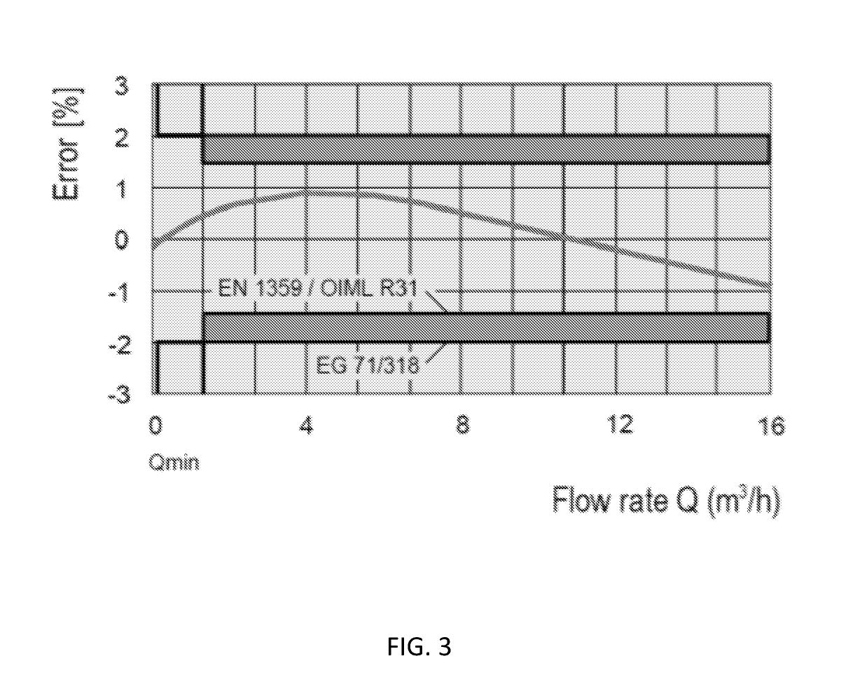

A gas meter subject to test conditions is known to have an acceptable accuracy that is referred to as its Error of Indication, EOI. FIG. 3 illustrates an example EOI curve in which a percentage error in the meter reading is plotted against a flow rate of gas through the meter. In an embodiment, the EOI of FIG. 3 relates to the meter 4 of FIGS. 1 and 2.

As can be seen from FIG. 3, the EOI is not a straight line and therefore a newly installed meter will have a variable degree of accuracy depending on where in its range of operation a meter is operating. For example, where the bellows of the meter are moving (e.g. expanding and contracting) at a rate which causes the meter to transmit gas at a flow rate of about 4.0 m³/h, the meter counter will have an inaccuracy of about 0.9%, that is, the meter will over-record the amount of gas transmitted. On the other hand, where the bellows of the meter are moving at a rate which causes the meter to transmit gas at a flow rate of about 10.7 m³/h, the meter counter will have an inaccuracy of about 0%, that is, the meter will accurately record the amount of gas transmitted. Additionally, where the bellows of the meter are moving at a rate which causes the meter to transmit gas at a flow rate of about 16.0 m³/h, the meter counter will have an inaccuracy of about −0.9%, that is, the meter will under-record the amount of gas transmitted.

In an embodiment, FIG. 3 illustrates an example EOI curve of a U10 meter. A U10 meter may be installed so as to provide a flow rate of up to 10 m³/hour. Therefore, during normal operation, the meter would typically be used to provide a flow rate of up to but not exceeding 10 m³/hour. Accordingly, during normal operation the U10 meter would tend to over-record the amount of gas transmitted.

As from Oct. 30, 2016, the European Measuring Instruments Directive, MID came into UK law and all new gas meter installations will need to comply with this Directive. The introduction of MID raises some important issues of metrological accuracy as MID includes Class 1.5 (domestic gas meters) where the maximum permissible error, MPE, ranges from ±3% at the lower zone of the meter's operation and ±1.5% at the upper zone. However, MID also introduces a new concept of In-Service accuracy that increases the lower zone MPE up to ±6%.

Two example gas meters are U6 or G4 where the number refers to the nominal volume of gas flow as ft³ or m³ per hour. That is, the U6 nominally provides a gas flow of 6 m³ per hour, whereas the G4 nominally provides a gas flow of 4 m³ per hour. Gas consumed through a gas meter is often used by a boiler for heating and, historically, a boiler had a fixed gas rate sufficient to meet peak load. However, new gas boilers, for example, condensing gas boilers are self-modulating on their gas rate. Just like a radio can play music quiet or loud, a gas boiler can similarly adjust its gas rate to very low levels in order to be more efficient.

However, a low modulating boiler places the gas meter in its least accurate EOI range, for example, a standard U6 meter can have an EOI curve approaching +1%±0.5% in its lower zone of operation that ranges from 0.04 m³/hour to 1 m³/hour with an acceptable In-Service accuracy of ±6%. Whereas a 28 kW heating boiler with a 10/1 modulation range has a lower gas rate of 0.27 m³/hour. Therefore, it can be seen that a boiler operating in this region of the gas meters operating zone is subject to potential overcharging by virtue of over-recording at the meter in line with the EOI, the best accuracy. The meter can have future predictable meter drift rates that may increase to 6% and still be considered accurate for the purposes of preparing gas bills and the MID.

The EOI curve of a gas meter may be influenced by the meter manufacturer's customer, the energy supplier and, as a consequence, the EOI and future meter drift rates are inclined to over-read gas volume.

The aspect of a meter's lower zone of operation and modulating boiler is highlighted further by the fact that an average UK household will use approximately 18,000 kWhs of gas energy per year, including 2,500 kWhs for domestic hot water. The majority of gas boiler installations now comprise a combination boiler that provides both space heating and all year round on-demand domestic hot water. In order to fulfil this typical heat demand a boiler is required to perform approximately 16,500 start/stop operations per year and, with the average life expectancy of a modern gas boiler being around 10 years, this equates to a life time operation of 165,000 start stop operations. A gas meter may be installed for thirty years or more with an in-service life of over 500,000 start/stop operations.

It can be seen that improved gas boiler efficiency can place the gas meter in its least accurate range of operation and will, therefore, cause over-recording at the meter which artificially increases gas bills by the known EOI rate, plus predictable and non-predictable meter drift or error rates.

In summary, therefore, a displacement volumetric meter, such as meter 4, transmits and meters a fluid (e.g. fuel gas). Due to the structure and function of the meter 4, its measurements are subject to a measurement error which varies in accordance with the flow rate of fluid transmitted by the meter 4. Accordingly, depending on the flow rate, the meter 4 can over-record, accurately record, or under-record. In turn, gas utility companies can charge a gas consumer for a quantity of gas which is different from the actual quantity of gas transmitted by the meter 4. Moreover, due to the normal operation of some appliances (e.g. gas boilers), the meter 4 may tend to over-record more than it accurately records or under-records. Since over-recording can lead to gas utility companies overcharging for gas consumption, these measurement errors can cause gas consumers to over pay for their gas consumption.

In addition to the above, there is a further reason why gas utility companies can inaccurately charge gas consumers for their gas. This is based on the method by which a quantity of gas which is consumed (e.g. by a gas consumer) is converted into a quantity of energy which is billed (e.g. by a gas utility company). Specifically, as a society, energy is needed to perform daily tasks and, as a result, energy is often conceptualised as fuel. For example, a bag of coal or a litre of petrol may be purchased and the purchaser may not be aware of its energy content. However, gas is a different entity as a gas meter records volume of gas transmitted, not energy. For example, the meter 4 measures bellow movement, for example, the number of times the bellows expand and contract. This provides a measure of the number of times the meter 4 transmits its fixed volume of gas. Since the meter measures gas volume transmitted, there is a need to convert gas volume into energy, e.g. for billing purposes. In the UK, since 1997 this has been achieved by way of using a Government agreed formula 1.02264.

The standard formula 1.02264 for gas meters using less than 723,000 kWhs per annum makes assumptions that the temperature of the transmitted gas is 12.2 degrees Centigrade and that the atmospheric pressure is set at 66 meters above sea level. Therefore, if a gas consumer receives gas at a temperature different from 12.2 degrees Centigrade, they will be inaccurately charged for energy. Specifically, if the gas temperature is below 12.2 degrees Centigrade they will be under charged, whereas if the gas is above 12.2 degrees Centigrade they will be over charged. Also, if a gas consumer receives gas at an atmospheric pressure different from that at 66 meters above sea level, they will be inaccurately charged for energy. Specifically, if the pressure is below that at 66 meters above sea level they will be under charged, whereas if the pressure is above that at 66 meters above sea level they will be over charged.

It is noted that the assumed values of temperature and pressure may vary over time as regulations evolve and develop. Also different countries may use different assumed values of temperature and pressure compared to the UK. Furthermore, it has been determined by the inventor that the formula used in the UK is inaccurate and, in fact, uses a value for the atmospheric pressure at 64.5 meters above sea level.

The UK Government is now embarking on a national upgrade of gas meters to Smart meters. However, smart meters are subject to MID levels of accuracy. A smart meter may record gas use through ultra-sonic sound waves that detects the flow of gas across two or more points within the gas stream. The rate of flow is determined by subtracting time differences between two points, for example, A to B, and B to A. The installation of Smart meters is set to cost over £11 bn and there are thought to be concerns about cost and accuracy of the programme. Additionally, a gas smart meter may be of traditional construction with an updated volume recorder and communications module to enable data transfer of metered gas volume. In any case, gas meters are relaying on prescribed MID levels of accuracy and a volume correction formula that will cause financial errors in gas bills.

Gas meters and gas billing are both subject to averaged accuracy assumptions that through research now identifies the systemic overcharging of gas. Since the introduction of 1,02264 the overcharge of gas is now estimated at over £1 bn and by 2030 will be over £2 bn, equating to an overestimation of carbon emissions of around 10 mt of CO².

In summary, therefore, gas volume is converted into energy for billing purposes. However, a gas volume will vary with temperature and pressure. For example, a fixed number of gas atoms will occupy a larger volume at a lower pressure or a higher temperature, whereas it will occupy a smaller volume at a higher pressure or a lower temperature. Therefore, the temperature and pressure at which a displacement volumetric meter (e.g. meter 4) transmits a fluid (e.g. gas), determines how much gas (e.g. how many gas atoms) is contained in a fixed volume. Stated differently, the temperature and pressure at which a displacement volumetric meter transmits a fluid determines the amount of energy in its fixed volume of gas. Accordingly, a first gas consumer with a meter in a cool, low altitude location will be charged less for the same quantity of energy as a second consumer with a meter in a hot, high altitude location.

Various embodiments of the apparatus 12 for determining a measurement error of the meter 4 aim to correct for the above-mentioned measurement error which varies in accordance with the flow rate of fluid transmitted by the meter. Additionally, some embodiments aim to correct for the above-mentioned inaccuracies associated with temperature and pressure.

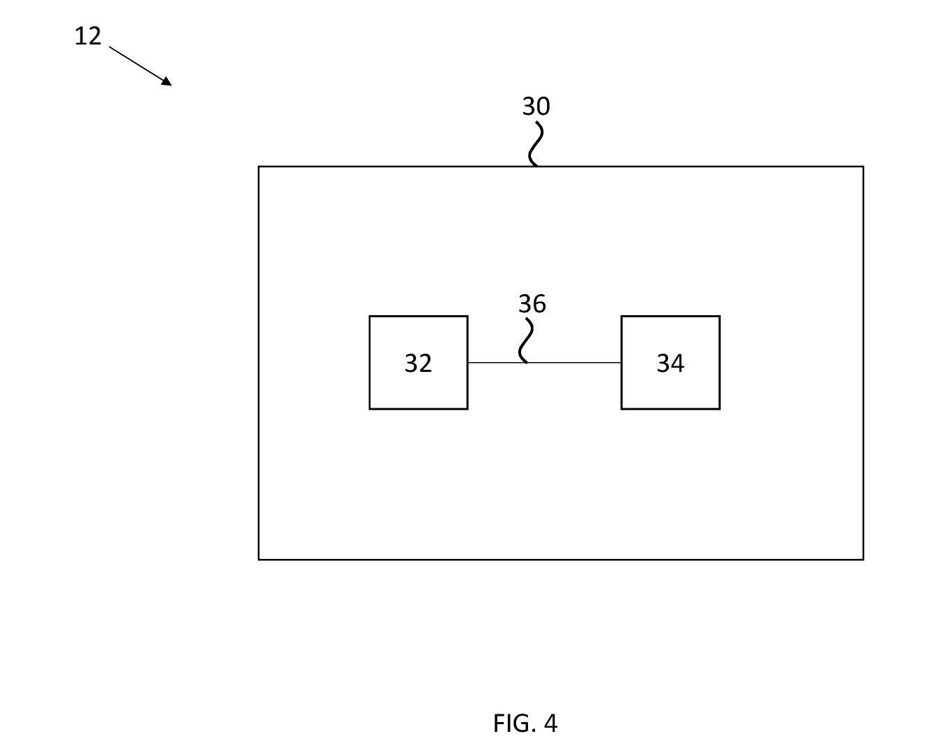

FIG. 4 illustrates the apparatus 12 for determining a measurement error of the displacement volumetric meter 4. The meter 4 has bellows which in use move (e.g. expand and contract) to transmit a fluid, such as fuel gas. It should be understood that in different embodiments a different type of displacement volumetric meter maybe used to the meter 4.

The apparatus 12 includes a housing 30 containing a transducer 32 in communication with a computing device 34. The housing 30 may be weatherproof. The transducer 32 is operable to detect movement of the bellows 24, for example, a cyclic expansion and contraction of the bellows 24. Also, the transducer 32 is operable to generate a signal (e.g. an electronic signal) which varies in accordance with the movement of the bellows 24. It is to be understood that the apparatus 12 may also include a power source (not shown) for powering elements of the apparatus 12, The power source may include one or more batteries located inside the housing 30.

In an embodiment, the apparatus 12 is positioned inside the housing 18 of the meter 4 such that the transducer 32 detects movement of the bellows 24. For example, the apparatus 12 may be attached to an internal surface of the meter 4 (e.g. an internal surface of the housing 18) and the transducer 32 may be a mechanical switch which is positioned so that movement (e.g. expansion or contraction) of one of the bellows (e.g. bellow 24a) activates the mechanical switch. In this way, a switch signal is generated from which can be determined bellow movement. For example, the switch signal may default to a low output, but may temporarily produce a high output when activated by movement of the bellow 24a. Accordingly, the mechanical switch can both detect movement (e.g. a cyclic expansion and contraction) of the bellows and generate a signal which varies in accordance with the movement. It is to be understood that the mechanical switch may partially protrude from the housing 30 in order that bellow movement activates the switch.

In another embodiment, the mechanical switch may be replaced by another type of transducer, such as, an optical sensor. The optical sensor may be configured in use to generate an electronic signal which varies in accordance with light incident on a surface of the optical sensor. The optical sensor may be positioned such that movement (e.g. expansion or contraction) of one of the bellows 24 (e.g. bellow 24b) causes a discernable change in the level of light incident on the surface of the optical sensor and, therefore, the magnitude of the electronic signal. For example, when expanded the bellow 24b may temporarily cover the surface of the optical sensor thereby blocking light (e.g. from a light source located inside the meter 4) to the surface of the optical sensor, but when contracted the bellow 24b may be spaced from the surface of the optical sensor thereby permitting light (e.g. from the light source) to reach the surface. Accordingly, the optical sensor can both detect movement (e.g. a cyclic expansion and contraction) of the bellows 24, and generate a signal which varies in accordance with the movement.

In a further embodiment, the transducer 32 is a vibration sensor positioned to detect vibrations generated or caused by the movement (e.g. cyclic expansion and contraction) of the bellows 24. In this embodiment, the vibration sensor generates a signal which varies in accordance with the detected vibrations. The vibration sensor may be a microphone and the signal may be an audio signal (e.g. a .wav file). In an embodiment, the housing 30 containing the vibration sensor is located inside the meter 4, such as, for example, fixed to an internal surface of the housing 18. In another embodiment, the housing 30 containing the vibration sensor is located outside of the meter 4. In this case, the housing 30 may be fixed to the meter 4 via an attachment mechanism of the apparatus 12. The attachment mechanism may include one or more magnets or straps. In a further embodiment, if the vibration sensor is sensitive enough, the housing 30 containing the vibration sensor may be spaced from the meter 4, that is, the housing 30 maybe fixed to the meter 4 via an intermediate element or may be spaced from the meter 4, for example, fixed to a wall or structure adjacent to (but spaced from) the meter 4. In yet a further embodiment, the housing 30 may be absent, that is, the apparatus 12 may include only the transducer 32 in communication with the computing device 34. Such an embodiment may be more suitable for location within the meter 4.

In any case, the transducer 32 is positioned to detect movement (e.g. a cyclic expansion and contraction) of the bellows 24 and to generate a signal which varies in accordance with the movement of the bellows 24.

For the sake of clarity, in the following description, it is to be understood that the transducer 32 is a vibration sensor, and that the transducer 32 and computing device 34 are located within the housing 30. The housing 30 includes an attachment mechanism for attaching the housing 30 to an outer surface of the meter 4. In an embodiment, the meter housing 18 is metallic and the attachment mechanism comprises one or more magnets such that the housing 30 can be fixed to the meter 4 by magnetic attraction. Alternatively, the meter attachment mechanism may include one or more straps which encircle part of the meter 4 to fix the housing 30. In an embodiment, the housing 30 is fixed to the meter 4 by an adhesive.

The computing device 34 is in communication with the transducer 32 so as to receive the transducer signal therefrom. In an embodiment, communication is via a link 36. The link 36 may be or may include an electric conductor such as a copper track, an electric cable or a metal wire. In an embodiment, the computing device 34 is a microcontroller, but it is to be understood that in some other embodiments, the computing device 34 may be one or more general purpose computers, an application specific integrated circuit (ASIC) or the like. In an embodiment, the computing device may include at least one processor and at least one memory containing computer executable code which when executed by the at least one processor causes the computing device to operate as explained below.

In use, the computing device 34 is operable to calculate a flow rate of fluid through the meter 4 based on the signal received from the transducer 32 via the link 36. Also, the computing device 34 is operable to determine a measurement error of the meter 4 based on the calculated flow rate. It is to be understood that for a given flow rate calculation the computing device 34 may operate on only a time slice, window or portion of the signal. For example, the computing device 34 may use a certain number of seconds of the signal, such as, 1, 2, 5, 10, 15, 30, 60, 100 seconds. It is to be understood that the number of seconds of the signal used by the computing device 34 for a given calculation may vary between calculations and embodiments.

In an embodiment, the computing device 34 receives the signal from the transducer 32, wherein the signal varies in accordance with the detected vibrations that are caused by the movement of the bellows 24. As such, a cyclic variation in the signal indicates each time the bellows 24 expand and contract. For example, the signal has a cyclic or periodic waveform, and each cycle or period of the waveform corresponds to the transmission of a volume of fluid by the meter 4, wherein the volume equals the fixed volume of the meter 4. This fixed volume is a constant value associated with the meter 4. In an embodiment, the computing device 34 includes a storage device (e.g. a memory) having this fixed volume constant value stored thereon. Accordingly, if the fixed volume of the meter 4 is 0.1 m³, each cycle or period of the signal represents the transmission of 0.1 m³ of fluid by the meter 4.

In an embodiment, the computing device 34 can analyse the signal (or a portion thereof) from transducer 32 to determine the number of cycles. The number of cycles can be used to determine the number of times the fixed volume is transmitted over the total time interval of the signal, In this way, a rate of expansion and contraction of the bellows 24 can be determined from a variation of the signal. In turn, the computing device 34 can calculate a flow rate at which fluid is transmitted by the meter 4. For example, the computing device 34 can multiply the number of cycles in the signal by the fixed volume, and then divide the result by the total time interval of the signal. This result could then be normalised to a specific unit, such as, m³ per hour, In this way, the computing device 34 can calculate a flow rate of fluid through the meter 4 based on the signal. It is noted that this calculation can be performed with complete cycles and/or portions of cycles. Also, the size of the signal portion used may vary between calculations and embodiments.

As mentioned above, each meter is associated with an EOI, wherein an EOI defines a measurement error of the meter with respect to a flow rate of fluid through the meter. An example EOI is provided by FIG. 3 and is discussed above. Therefore, the computing device 34 can use the above-determined flow rate with the EOI of the meter 4 to determine a measurement error of the meter 4. In an embodiment, the computing device 34 includes a storage device (e.g. a memory) having the EOI stored thereon, for example, in the form of a look up table. Accordingly, the computing device 34 can determine a flow rate of the meter 4 based on the signal, as described above, and can then use the EOI to identify a measurement error corresponding to that flow rate. For example, considering FIG. 3, if the computing device 34 calculated a flow rate of 4 m³/h based on the signal received from the transducer 32, the flow rate of 4 would be stored with an associated measurement error of 0.9% in the look up table. In this way, the apparatus 12 can determine a measurement error of the meter 4. In an embodiment, the computing device 34 is a meter measurement error determining device.

The following describes an additional or alternative mechanism by which the apparatus 12 can determine a measurement error of the meter 4.

In an embodiment, the computing device 34 includes a storage device (e.g. a memory). Stored on the storage device are a plurality of stored vibration signals. In this context the term ‘vibration signal’ is taken to mean an electronic representation of a mechanical vibration and includes, for example, sound or audio electronic files (e.g. a .wav file). In any case, each stored vibration signal is stored with an associated flow rate. In an embodiment, each stored vibration signal is an electric representation of mechanical vibrations generated by a meter transmitting fluid at a given flow rate, and each stored vibration signal is stored with its associated given flow rate. That is, the stored vibration signals represent movement of meter bellows.

Additionally, the computing device 34 is operable to compare the signal (or a portion thereof) received from the transducer 32 with the plurality of stored vibration signals (or portions thereof) to identify a matching stored vibration signal. The computing device 34 is then operable to determine the associated flow rate stored with the matching stored vibration signal.

In an embodiment, any matching algorithm may be performed by the computing device 34 to identify the matching stored vibration signal. For example, the computing device 34 may identify a match if one or more characteristics (e.g. period, amplitude range, frequency, etc.) of the signal (or portion thereof) are the same as or similar to corresponding characteristics of a stored vibration signal (or portion thereof). Additionally or alternatively, a match may be found if a profile (e.g. the size and location of peaks and/or troughs) of the signal and a stored vibration signal are the same or similar. A similarity threshold may be used to identify sufficient similarity to qualify as a match. The similarity threshold may vary between different embodiments. Additionally or alternatively, matching may be performed based on a voice or music recognition algorithm, as described below.

In an embodiment, the computing device 34 may include a voice recognition module and may identify the matching stored vibration signal using a voice recognition algorithm. For example, voice recognition is concerned with comparing a sample voice sound with a plurality of stored voice sounds in order to identify a matching stored voice sound. The matching stored voice sound is stored with an associated word or phrase and, in this way, the voice recognition process receives a sample sound and provides or ‘recognises’ a word or phrase. The process in respect of this embodiment is analogous in that the computing device 34 receives a sample vibration signal (i.e. an electronic representation of a mechanical vibration—like a voice sound) and provides or ‘recognises’ a flow rate (i.e. a text string—similar to a word or phrase).

In an alternative embodiment, the computing device 34 may include a music recognition module and may identify the matching stored vibration signal using a music recognition algorithm. For example, music recognition is concerned with comparing a sample music sound with a plurality of stored music sounds in order to identify a matching stored music sound. The matching stored music sound is stored with associated song details and, in this way, the music recognition process receives a sample music sound and provides text. The process in respect of this embodiment is analogous in that the computing device 34 receives a sample vibration signal (i.e. an electronic representation of a mechanical vibration—like music sound) and provides a flow rate (i.e. a text string—similar to song details).

In any case, the computing device 34 compares the signal (or portion thereof) with a plurality of stored vibration signals (or portions thereof) to identify a matching stored vibration signal, and determines the flow rate from an associated flow rate stored with the matching stored vibration signal. At this point the operation of the computing device 34 in determining the measurement error from the flow rate may be as described above.

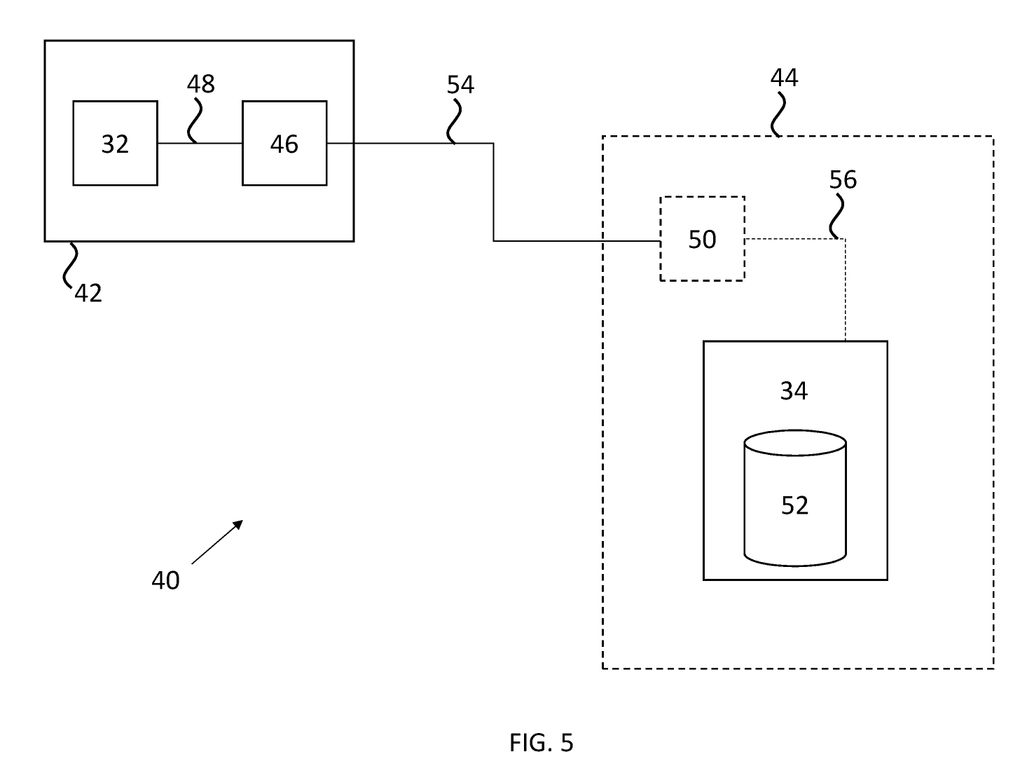

As described above, in an embodiment, the apparatus 12 may include the transducer 32 and the computing device 34 without the housing 30. In this case, the apparatus 12 may have a distributed architecture. That is, the transducer 32 maybe positioned inside, on or near to the meter 4, but the computing device 34 may be positioned in a different location, such as, inside the building 6, or in a different building, city, country or continent. In this case, the link 36 may be or may include a wireless communication channel. A further embodiment utilizing a wireless communication channel will now be described with reference to FIG. 5.

FIG. 5 illustrates an apparatus 40 for determining a measurement error of the meter 4, in accordance with an embodiment. The apparatus 40 includes a meter unit 42 and a base unit 44. The meter unit 42 includes the aforementioned transducer 32. As before, in this embodiment, the transducer 42 is a vibration sensor, such as a microphone. The meter unit 42 also includes a transmitter 46 in communication with the transducer 32 via a link 48 so as to receive the signal (or a portion thereof) therefrom. The link 48 may be or include an electric conductor such as a copper track or an electric wire. In operation, the transmitter 46 is operable to transmit data containing the transducer signal (or a portion thereof). In an embodiment, the meter unit 42 is a meter monitoring device for a displacement volumetric meter. In an embodiment, the computing device 34 is a meter measurement error determining device.

In an embodiment, the base unit 44 includes a receiver 50 and the aforementioned computing device 34. The computing device 34 includes a storage device 52. The receiver 50 is in communication with the transmitter 46 via a communication channel 54. The communication channel 54 may be wired, wireless, or partly wired and partly wireless. In an embodiment, the communication channel 54 may include one or more computer networks, such as, the Internet. In any case, the receiver 50 is configured to receive the data transmitted from the transmitter 46 via the communication channel 54. Also, the receiver 50 is in communication with the computing device 34 via a link 56. The link 56 may be a direct link between the receiver 50 and the computing device 34. As such, the link 56 may be an electric conductor such as a copper track or an electric wire. Additionally or alternatively, the link 56 may include one or more computer networks, such as, the Internet. As such, the computing device 34 may be located in a different city, country or continent to the transducer 32, but the computing device 34 is operable to obtain the signal from the transducer 32.

Comparing the embodiments of FIGS. 4 and 5, the link 36 of FIG. 4 is analogous to the following features of FIG. 5: the link 48, the transmitter 46, the communication channel 54, the receiver 50 and the link 56. As such, the embodiment of FIG. 5 provides an alternative mechanism for communicatively coupling the transducer 32 with the computing device 34. In an embodiment, the transmitter 46 is a wireless transmitter, such as, a radio frequency (RF) transmitter (e.g. a Wi-Fi transmitter, or a Bluetooth™ transmitter). The transmitter 46 provides a means for sending the transducer signal (or a portion thereof) away from the meter 4 and to the computing device 34 for processing. In an embodiment, the transmitter 46 may be used to connect the meter unit 42 to a computer network (e.g. Wi-Fi network) present in the building 6. In this embodiment, the receiver 50 may be a wireless receiver (e.g. a Wi-Fi router) located inside the building 6. Also, the link 56 may represent a wired and/or wireless connection between the receiver 50 and the computing device 34, via the Internet. As such, the base unit 44 may have a distributed architecture.

In an alternative embodiment, the computing device 34 may be directly connected to the receiver 50 such that both elements are co-located in the building 6. As such, the base unit 44 may include a single housing containing both the receiver 50 and the computing device 34.

It is to be understood that the base unit 44, the receiver 50 and the link 56 may not be present in all embodiments, as indicated by the phantom lines. Instead, these elements provide an example mechanism for linking the transmitter 46 to the computing device 34 via the communication channel 54, so that the computing device 34 receives the transducer signal.

In summary, therefore, the apparatus 40 includes the meter unit 42 having the transducer 32 in communication with the transmitter 46. The transmitter 46 receives the signal from the transducer 32, and the transmitter 32 transmits the signal. The computing device 34 is in communication with the transmitter 46 via a communication channel 54 so as to receive the signal therefrom. In an embodiment, this communication may be via the receiver 50 and link 56. However, in some other embodiments, this communication may be direct between the computing device 34 and the transmitter 46, for example, the computing device 34 may include the receiver 50. Alternatively, this communication maybe via one or more computer networks, such as the internet. For example, the computing device 34 may include a mechanism for connecting to the Internet, such as, a wired Ethernet connection.

In an embodiment, the meter unit 42 is positioned inside, on or near to the meter 4 such that the transducer 32 can detect movement (e.g. a cyclic expansion and contraction) of the bellows 24 and generate a signal which varies in accordance with the movement.

The transducer 32 provides the signal to the transmitter 46. The transmitter 46 transmits data containing the signal (or portion thereof) to the computing device 34 via the communication channel 54. The computing device 34 then determines a flow rate of fluid through the meter 4 based on the received signal, and determines a measurement error of the meter 4 based on the determined flow rate, In this way, the apparatus 40 determines a measurement error of the meter 4.

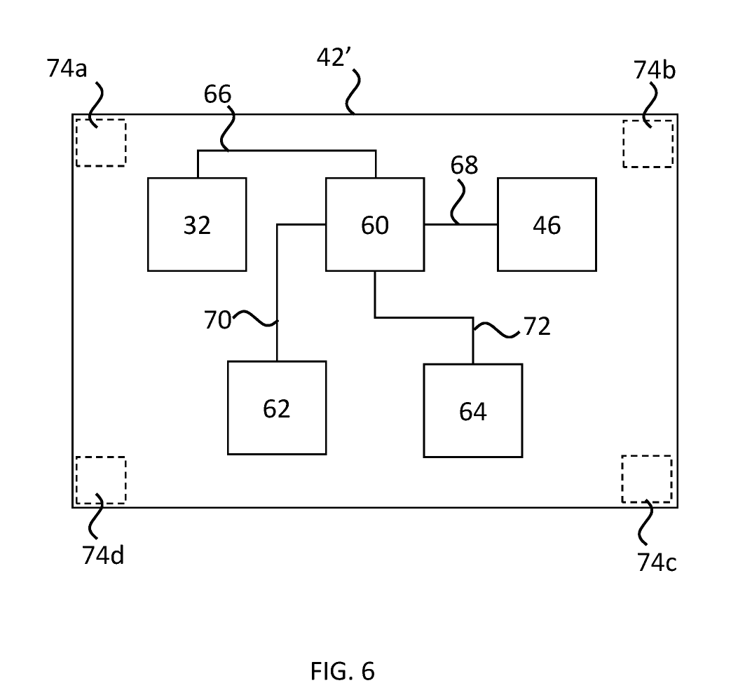

FIG. 6 illustrates a possible extension to the embodiment of FIG. 5. For clarity, FIG. 6 shows only the meter unit 42′; however, it is to be understood that the embodiment also includes at least the communication channel 54 and computing device 34 of FIG. 5. In an embodiment, the meter unit 42′ is a meter monitoring device for a displacement volumetric meter.

As before, the meter unit 42′ includes the transducer 32 and the transmitter 46. However, the meter unit 42′ also includes a processing device 60, a temperature sensor 62 and a pressure sensor 64. The processing device 60 is in communication with the transducer 32 via a link 66, and the processing device 60 is in communication with the transmitter 46 via a link 68. In this way, the processing device 60 is coupled between the transducer 32 and the transmitter 46. Also, the temperature and pressure sensors 62, 64 are in communication with the processing device 60 via respective links 70, 72. Further, the meter unit 42′ includes a meter attachment mechanism in the form of a plurality of magnets 74a-d. In use, the magnets 74a-d fix the meter unit 42′ to a metallic outer surface of the housing 18 of the meter 4.

The following describes the purpose and operation of the processing device 60, following which are described the purpose and operation of the temperature and pressure sensors 62, 64.

In an embodiment, the processing device 60 is a microcontroller, but it is to be understood that in some other embodiments, the processing device 60 may be an application specific integrated circuit (ASIC) or the like. In an embodiment, the processing device 60 includes an analog-to-digital converter (ADC), a fast Fourier transform module, and/or a general purpose computer. In an embodiment, the processing device 60 may include at least one processor and at least one memory containing computer executable code which when executed by the at least one processor causes the processing device to operate as explained below.

In use, the processing device 60 is operable to process the signal output from the transducer 32 before transmission by the transmitter 46. The nature of the processing applied to the signal may vary between different embodiments. For example, in an embodiment, the processing device 60 is operable to encrypt the signal (or portion thereof), for example, to prevent a malicious party from obtaining the signal from the transmitted data. The encryption may be performed based on a public-private key encryption algorithm. It is to be understood that the computing device 34 would be operable to decrypt the data received by the receiver 50 so as to obtain the signal (or portion thereof). That is, the computing device 34 may store the private key in the storage device 52.

In an embodiment, the processing device 60 is operable to digitize the signal (or a portion thereof). Additionally or alternatively, the processing device 60 is operable to generate a frequency domain representation of the signal (or portion thereof) and to discard frequencies which are outside a predetermined frequency range. For example, the frequencies associated with the movement (e.g. expansion and contraction) of the bellows 24 may occur within a specific frequency range. As a result, the processing device 60 may generate a frequency domain representation of the signal and discard all frequencies outside the specific frequency range. Accordingly, only a portion of the signal which directly relates to the vibrations generated by movement of the bellows 24 is passed to the transmitter 46 for transmission.

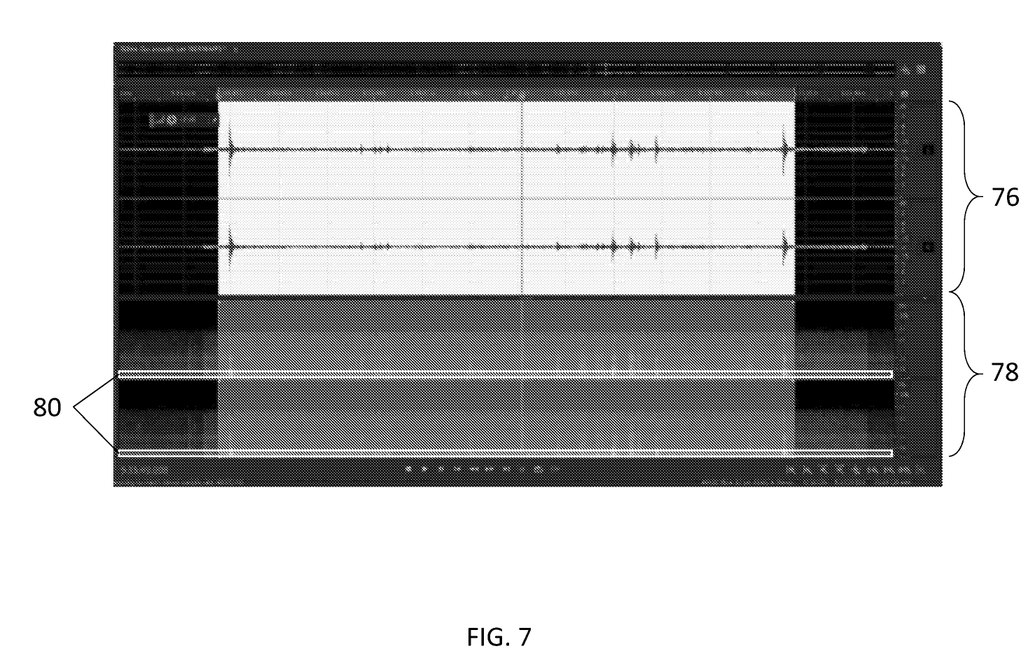

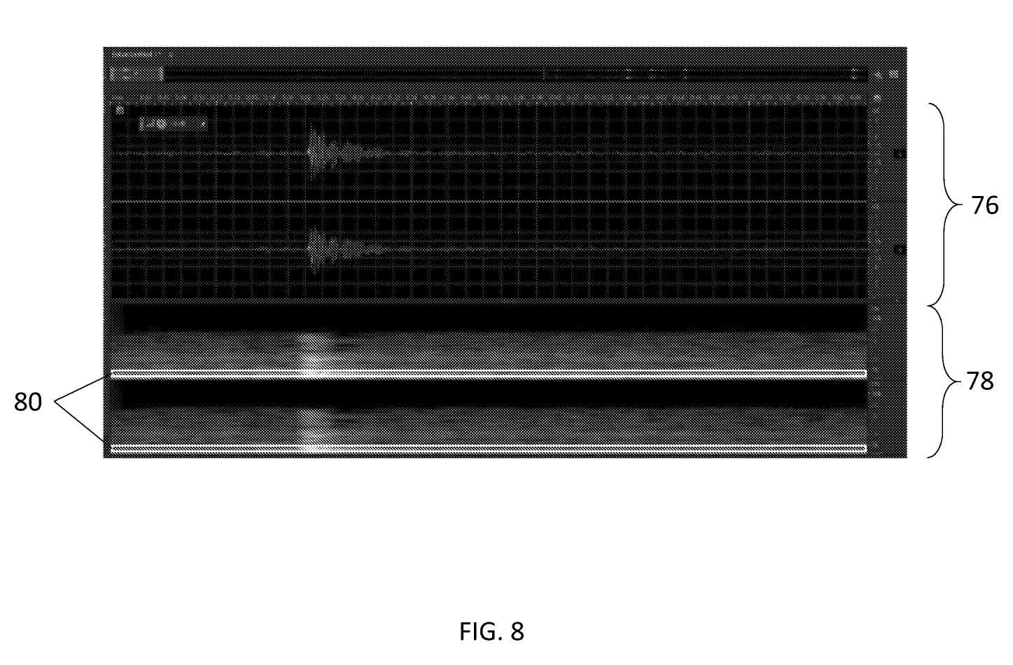

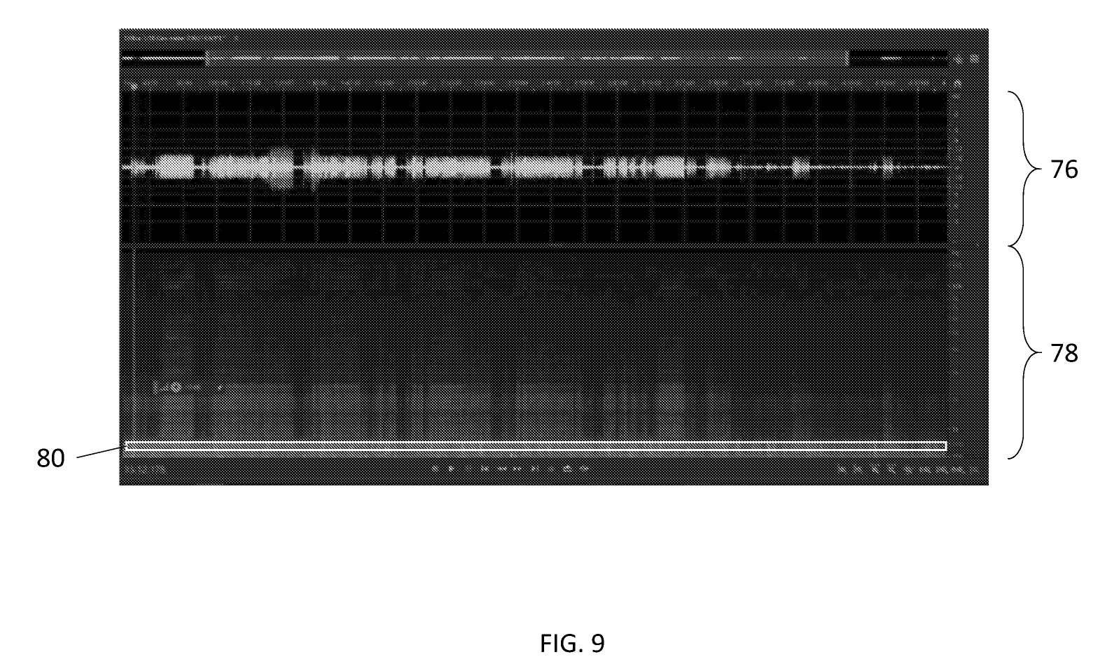

FIGS. 7 to 9 provide example waveforms illustrating the operation of the processing device 60 in discarding frequencies of the signal which are outside a predetermined frequency range. Specifically, the processing device 60 receives from the transducer a signal representing the change in magnitude of vibrations generated by the meter 4 over time. This signal may be digitized by the processing device 60. In each of FIGS. 7 to 9, a time domain representation of the signal is labelled 76 (decibels vs. time). In operation, the processing device 60 generates a frequency domain representation which is labelled 78 (Hz vs. time). Furthermore, of the frequencies identifiable in 78, only those in the box labelled 80 correspond to vibrations caused by the movement (e.g. expansion and contraction) of the bellows 24. The frequencies outside the box 80 may relate to other vibrations caused by the meter 4 (e.g. movement of the metering mechanism) or by some external source (e.g. ambient noise caused by traffic, people, etc.) Therefore, the processing device 60 may pass to the transmitter 46 only the portion of the signal which relates to the box 80. In this way, a quantity of the data transmitted is reduced, thereby reducing the power and time needed to transmit the data.

In an embodiment, the processing device 60 is configured to pass to the transmitter 46 not only frequencies of the signal which relate to the movement of the bellows 24, but also other aspects of the operation of the meter 4. As mentioned above, during operation of the meter 4, the bellows 24 move generating mechanical vibrations which can be detected by the transducer 32 such that a rate of expansion and contraction of the bellows 24 can be determined by the computing device 34. Additionally, the meter 4 may generate mechanical vibrations when performing other operations, and these operations may be identifiable in the transducer 32 signal by corresponding mechanical vibrations. For example, the metering mechanism of the meter 4 may count using a series of rotating dials, wherein each dial corresponds to a different part of the number count, for example, ones, tens, hundreds, thousands, etc. The movement of each dial may be separately identifiable in a specific frequency range of the transducer 32 signal. Accordingly, the processing device 60 may be configured to isolate that specific frequency range and pass it to the transmitter 46 for transmission so that the computing device 34 can determine the current counter number from the received data. It is to be understood that the above-described matching techniques could be used to match the received vibrations with a corresponding counter number.

Additionally or alternatively, the meter 4 may generate mechanical vibrations within a specific frequency range when experiencing a gas leak or other fault or malfunction. Therefore, the processing device 60 may be configured to isolate the frequencies of the signal corresponding to such faults and pass the corresponding portion of the signal to the transmitter 46 for transmission. The computing device 34 can then analyse the signal to identify the faults from the corresponding vibrations. It is to be understood that the above-described matching techniques could be used to match the received vibrations with a corresponding fault.

Additionally or alternatively, the meter 4 may generate mechanical vibrations which are indicative of its model, type or age. Therefore, the processing device 60 may be configured to isolate the relevant frequencies of the signal and pass the corresponding portion of the signal to the transmitter 46 for transmission. The computing device 34 can then analyse the signal to identify the model, type or age of the meter from the corresponding vibrations. It is to be understood that the above-described matching techniques could be used to match the received vibrations with a corresponding model, type or age of the meter 4.

Additionally or alternatively, the transducer 32 may be a microphone and may detect ambient noise surrounding the meter 4. For example, the meter 4 may be located by a road and, as such, the ambient noise may include a specific type of road or traffic noise. In any case, a representation of the ambient noise will be included in the signal and the processing device 60 can isolate specific frequencies of the signal which correspond to the ambient noise such that they are transmitted to the computing device 34. The computing device 34 can be configured to keep a log or record of the ambient noise and periodically compare the current representation of ambient noise with previously recorded representations of ambient noise. In this way, the computing device 34 can identify if the meter 4 (with transducer 32) has moved location. For example, if the meter 4 (with transducer 32) moved from an urban location to a rural location, this would be identifiable by the computing device 34 by comparing current and past representations of ambient noise. In this way, theft of the meter 4 (with transducer 32) may be detected by the computing device 34.

Returning to FIG. 6, the temperature and pressure sensors 62, 64 are in communication with the processing device 60 via respective links 70, 72. Each sensor is operable to generate information which varies in accordance with the environment of the base unit 42′ or meter 4. For example, the temperature sensor detects changes in temperature and generates corresponding temperature information (e.g. an electronic signal). As such, variations in the temperature information correspond to variations in temperature at the base unit 42′. On the other hand, the pressure sensor 64 detects changes in pressure (e.g. atmospheric pressure) and generates corresponding pressure information (e.g. electronic signal). As such, variations in the pressure information correspond to variations in pressure at the base unit 42′. It is to be understood that in an embodiment, a single sensor may detect both temperature and pressure, and may provide combined temperature and pressure information.

In an embodiment, the temperature and pressure information is passed to the processing device 60 by the links 70 and 72. In operation, the processing device 60 packages the temperature and pressure information with the signal (or portion thereof) in the transmitted data. For example, the data package may include: data relating to a signal portion together with temperature and pressure information taken at approximately the same time as the signal portion. As discussed above, the signal portion may include only one or more specific frequency ranges of the signal.

On receipt of the data, the computing device 34 determines the temperature and pressure information from the received data and updates the measurement error based on the temperature and pressure information. For instance, as discussed above, the conversion from ‘gas quantity used’ to ‘energy quantity billed’ is based on a formula which assumes a certain temperature and pressure. For example, in the UK, the temperature is assumed to be 12.2 degrees Centigrade and the pressure is assumed to be atmospheric pressure at 66 meters above sea level. Where the actual temperature and pressure of the gas is different from the assumed values, an inaccurate energy conversion is performed, Therefore, the storage device 52 may store values of temperature with associated compensation (or conversion) factors, for example, in the form of a look up table. Also, the storage device 52 may store values of pressure with associated compensation factors, for example, in the form of a look up table.

Accordingly, the computing device 34 is operable to receive temperature information and identify a corresponding temperature compensation factor. The computing device 34 is then operable to combine the temperature compensation factor with the aforementioned measurement error in order that the measurement error also accounts for the temperature inaccuracy of the energy conversion. In an analogous manner, the computing device 34 is operable to receive pressure information and identify a corresponding pressure compensation factor. The computing device 34 is then operable to combine the pressure compensation factor with the aforementioned measurement error in order that the measurement error also accounts for the temperature inaccuracy of the energy conversion.

It is to be understood that the compensation factors correspond with the assumed values of temperature and pressure used in the formula for converting from gas volume consumed to energy billed. It is to be understood that in different embodiments, the assumed values of temperature and pressure may vary. That is, the assumed temperature may be different to 12.2 degrees Centigrade, or the assumed pressure may be different from the pressure at 66 (or 64.5) meters above sea level. Nevertheless, the compensation factors update the measurement error to account for the difference between the measured and assumed temperatures and/or the measured and assumed pressures.

In an embodiment, the base unit 42′ may further include a global positioning system (GPS) sensor (not shown) in communication with the processing device 60. The GPS sensor provides geographical coordinates of the base unit 42′ to the processing device 60. In operation, the processing device 60 may include the coordinates in the data for transmission. The computing device 34 can then identify the meter 4 from the coordinates in the received data. Additionally, the computing device 34 can identify any changes in location from any changes in the coordinates over time.

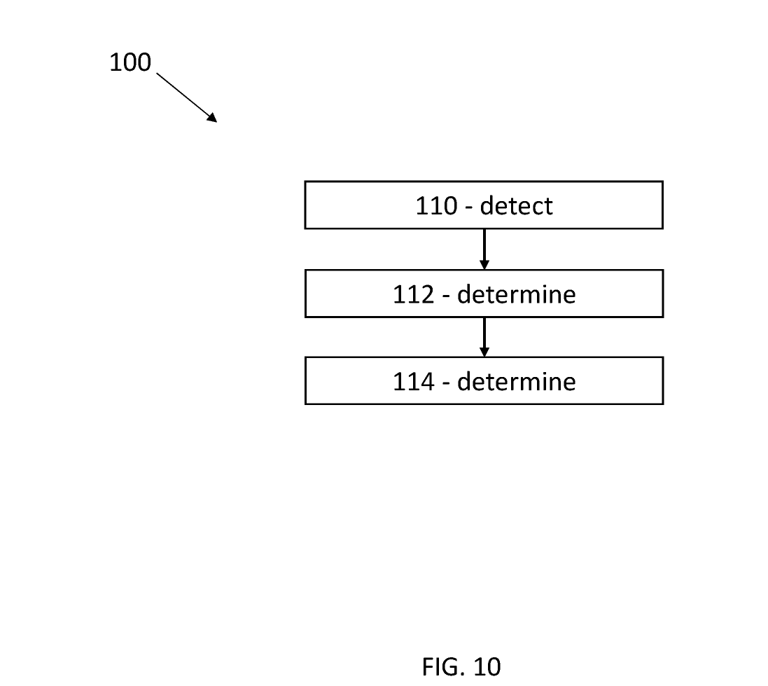

FIG. 10 provides a flow diagram 100 of a method of determining a measurement error of meter 4, in accordance with an embodiment. The flow diagram 100 may be performed by an apparatus as described with reference to at least some of the above-described embodiments.

At block 110, a movement (e.g. cyclic expansion and contraction) of the bellows of the meter 4 is detected. The movement of the bellows may be detected mechanically or optically. For example, the movement may be detected by the mechanical activation of a switch by the bellows as they expand. Alternatively, the movement may be detected optically via an optical sensor. Alternatively, the movement of the bellows is detected based on mechanical vibrations generated by the bellows' movement, For example, the mechanical vibrations may be detected by a vibration sensor, such as a microphone.

At block 112, a flow rate of fluid through the meter 4 is determined based on the movement of the bellows, For example, a rate of the cyclic expansion and contraction of the bellows may be identified, and then the flow rate may be calculated using: a predetermined meter volume and the identified rate of cyclic expansion and contraction of the bellows. The rate of cyclic expansion and contraction may be determined from a period or cycle of a signal produced by the aforementioned switch, optical sensor or vibration sensor,

At block 114, a measurement error of the meter 4 is determined based on the determined flow rate. For example, the determined flow rate may be compared to an EOI corresponding to the meter 4. The EOI may be stored in the form of a look up table.

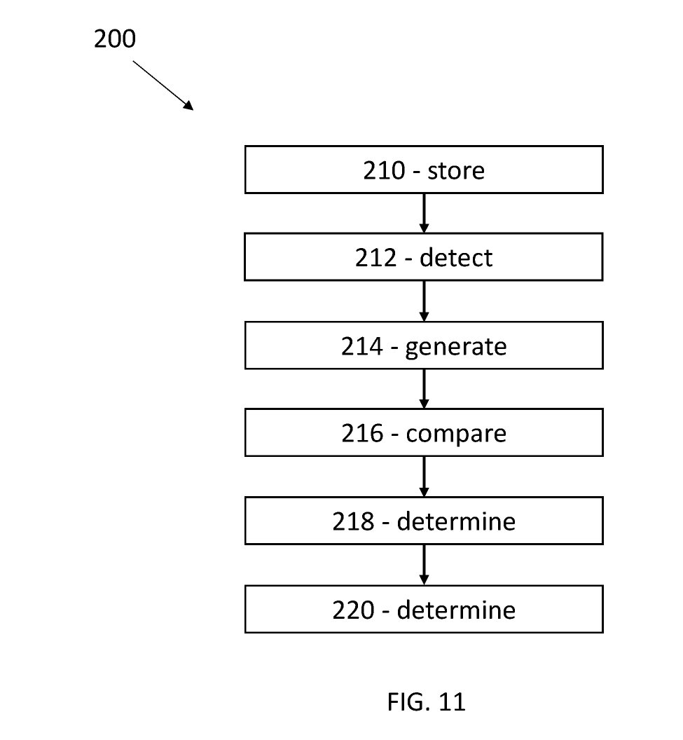

FIG. 11 provides a flow diagram 200 of a method of determining a measurement error of meter 4, in accordance with another embodiment. The flow diagram 200 may be performed by the apparatus as described above with reference to FIG. 6.

At block 210, a plurality of vibration signals are stored, Each stored vibration signal is stored with an associated flow rate. For example, the signals may be stored on a storage device of a computing device. Each signal may correspond to the vibrations generated by a meter when transmitting fluid at its associated flow rate.

At block 212, movement (e.g. a cyclic expansion and contraction) of the bellows is detected based on mechanical vibrations generated by the bellows moving. This may be achieved via a vibration sensor positioned inside, on or near to the meter 4.

At block 214, a signal is generated which varies in accordance with the detected vibrations. For example, the vibration sensor may be a microphone which generates a sound signal (e.g. an electronic signal such as a .wav file) based on the vibrations.

At block 216, the generated signal is compared with the plurality of stored vibration signals to identify a matching stored vibration signal. As described above, various matching algorithms may be used, such as, for example, a voice or music recognition algorithm.

At block 218, the flow rate of the meter 4 is determined from the associated flow rate stored with the matching stored vibration signal.

At block 220, a measurement error of the meter 4 is determined based on the associated flow rate. For example, the associated flow rate may be compared to an EOI corresponding to the meter 4. The EOI may be stored in the form of a look up table.

In further embodiments, the method may further include processing the generated vibration signal before comparing the generated vibration signal with the plurality of vibration signals. The nature of the processing may vary between embodiments. For example, the processing may include digitizing the generated vibration signal. Additionally or alternatively, the processing may include generating a frequency domain representation of the generated vibration signal, and discarding frequencies of the generated vibration signal which are outside one or more predetermined frequency ranges.

In further embodiments, one or more of the stored vibration signals is stored with associated further meter information. The further meter information may include meter type, meter model, meter age, meter reading, meter malfunction. For example, a stored vibration signal may correspond to the vibrations generated by a meter when experiencing a gas leak or when malfunctioning in some other manner. Also, a stored vibration signal may correspond to the vibrations generated by a meter once it has experienced a certain number of hours of operation. Also, a stored vibration signal may correspond to the vibrations generated by certain type or model of meter. That is, a meter of a first type/model may generate a first set of vibrations when transmitting fluid at a given flow rate, whereas a meter of a second type/model may cause a second set of vibrations when transmitting the same fluid at the same flow rate. In each case, the stored vibration signal is stored in association with the corresponding meter fault, meter age, or meter type/model. In this way, matching the stored vibration signal enables identification of the associated meter fault, age, type/model.

In further embodiments, the generated vibration signal may also vary in accordance with ambient noise at the meter. For example, where the vibration signal is a sound file generated by a microphone, the microphone may detect ambient noise surrounding the meter when detecting vibrations generated by the meter. In this case, the one or more previous versions of the ambient noise may be stored for comparison purposes. Also, the current ambient noise may be determined from the generated vibration signal and compared with previously stored ambient noise to identify a change in location of the meter, i.e. when the two sets of ambient noise do not sufficiently match.

In further embodiments, the method may include storing temperature and/or pressure information with one or more associated compensation factors. Also, the method may include generating temperature and/or pressure information which varies in accordance with an environment of the meter. The generated temperature and/or pressure information is then compared with the stored temperature and/or pressure to identify matching stored temperature and/or pressure information. The compensation factors associated with the matching stored temperature and/or pressure information are then used to update the measurement error.

According to the above-described embodiments, a flow rate of fluid transmitted by a meter and a measurement error of the meter is determined. Accordingly, a more accurate volume of gas transmitted by the meter can be determined. In this way, a gas consumer can use the measurement error to determine whether he or she is being under, or over, or accurately changed for gas. Also, a gas supplier can use this measurement error to determine whether it is under, or over or accurately charging for gas, and the gas supplier can adjust its charges accordingly. Additionally, a third party can determine charging inaccuracies and publish them for others to see, for example, on a website,

According to at least some above-described embodiments, a measurement error is adjusted to compensate for inaccuracies in converting a volume of gas consumed into an amount of energy charged. For example, compensation factors may be based on temperature and/or pressure. In this way, a gas consumer can determine whether he or she is being under, or over, or accurately charged for energy. Also, a gas supplier can determine whether it is under, over or accurately charging for energy, and the gas supplier can adjust its charges accordingly. Additionally, a third party can determine charging inaccuracies and publish them for others to see, for example, on a website.

In an embodiment, determined measurement errors may be stored on a database. The database may be stored on the storage device of the computing device or may be stored on another computer system, such as, a billing system of a gas supplier, an accounting system of a gas consumer, or a computer system of a third party. Additionally, in some embodiments, data may be manipulated based on the measurement errors. For example, a gas supplier may update its billing data based on the measurement errors, e.g. to improve their accuracy. Additionally or alternatively, a third party may update an entry on a website representing a gas consumer's bill to show by how much the gas consumer has been overcharged or undercharged. These comments apply analogously to the temperature and pressure compensation factors which may also be stored on a database and used to manipulate stored data.

According to some above-described embodiments there is provided a meter monitoring device for a displacement volumetric meter, Also, according to some above-described embodiments there is provided a meter measurement error determining device. It is to be understood that the meter monitoring device and the meter measurement error determining device may be separate and standalone products. However, in some embodiments the meter monitoring device and the meter measurement error determining device may be used together to determine a measurement error of a meter.

Various embodiments described above provide a low cost upgrade to existing gas meters through the addition of a microphone enabled device that is placed on a meter. The device incorporates an acoustic (i.e. sound) recognition and recording system in cooperation with a temperature, atmospheric pressure sensor and data transfer mechanism. Therefore, it is possible to more accurately calculate gas volume into gas energy and improve the accuracy of existing gas meters.

Various embodiments improve the metrology of gas through the use of acoustic (i.e. sound) recording that recognises the concept that a mechanical meter performs a repeated cyclical operation that produces a repeatable acoustic sound that is amplified through the gas meter. The acoustic sound of the meter is predictable and based on the design of the meter, for example the swept volume of the meter.

Various embodiments may compare the received or recorded acoustic sound profiles of the meter to a known or approximated acoustic pattern. Each type or model of gas meter has a recognisable acoustic pattern and an individual gas meter of a specific type or model may have slight variations much like we can recognise a finger print and then identify anyone by their own unique finger print.

Various embodiments may automatically detect the type or model of the meter that it is fitted to based on the meter's specific sound signature. Therefore, various embodiments may detect, based on the meter's specific sound signature, when the meter is switched to another meter, even one of a similar type or model.

An advantage of various embodiments is that it can work in cooperation with a remote energy billing database that records the occurrence of the acoustic pattern along with the local temperature, atmospheric pressure, time and usefully, the gas rate. By recording the rate of the acoustic pattern from the gas meter it is possible to know at what part of the gas meter range the meter was operating at the time the gas volume was recorded. Also by aligning gas rate with time of day it is possible to know the heat input characteristics of the property. Therefore, it is possible to enable various embodiments to communicate with a smart home energy monitoring and control system to better optimise the use of gas.

Various embodiments may also identify anomalies in gas meter accuracy as any changes the in the acoustic signature of the meter may point to a change in accuracy. Differences in acoustic recordings may point to increased meter drift rate or that a meter is operating outside of the regulatory standards.

Various embodiments recognise the concept that there is a database of acoustic gas meter recognition patterns and signatures for different types and models of gas meters, meaning that the device can be made for a specific type of meter or set to self-identify with any meter that it is paired.

According to various embodiments, it is possible to calculate the gas volume from a gas meter, and specifically a volume displacement gas meter, by way of comparing its cyclical acoustic recorded pattern with for example, but not limited to, the known swept volume of the meter. For example, a U6 meter has a swept volume of 2 dm³ and a U16 meter has a swept volume of 4 dm³.

According to various embodiments, gas meters can be identified by type or model from comparing the acoustic recorded pattern of a meter with stored acoustic patterns of a range of meters.

Various embodiments can lock to a specific meter as each meter has its own unique acoustic signature, analogous to a human fingerprint.

Various embodiments can record the start/stop operation of the meter along with gas flow rate and cross reference this with the known EOI and meter drift rates to improve the accuracy of gas bills.

Various embodiments can work in cooperation with a remote database to improve the accuracy of gas billing for domestic and non-domestic gas meters through the recording of local meter specific temperature and pressures.

Various embodiments can be used to upgrade the metrological accuracy of a gas meter and specifically a volume displacement gas meter and, in cooperation with a remote database, can produce smart billing data for gas bill generation.

Various embodiments can identify variations in the acoustic pattern or signature of a meter to help better determine meter drift rates or a meter that is operating outside of the prescribed regulatory limits.

Various embodiments introduce the concept of a low cost method by which to upgrade existing gas meters into Smart Billing Meters. A smart billing meter is one that can identify improved metrological accuracy through the correlation of acoustic patterns and meter specific sound signatures with known variables and meter specific environmental conditions.

Various embodiments identify gas rate and start/stop operations that enables the known EOI and meter drift rates of a gas meter to be included in the calculation methodology in preparing gas bills.

Various embodiments can also compare historical and current acoustic patterns of a gas meter to identify changes in the acoustic signature of the meter that may be the sign of increased metrological error, for example a meter that is performing outside of its regulatory limits.

Various embodiments can communicate with a cooperating remote database to help improve the accuracy of gas bills.

The features and advantages of various different embodiments are described above with reference to the Figures. It is to be understood that one or more features from one embodiment may be combined with one or more features of one or more other embodiments to form new embodiments which are covered by the scope of the appended claims. For example, the processing device 60 of the embodiment of FIG. 6 may be used in the apparatus 12 of FIG. 4 and/or the meter unit 42 of FIG. 5. In this way, the transducer signal of FIGS. 4 and 5 may be processed as described before reaching the computing device. Alternatively, the computing device of FIG. 4 may perform at least some of the functionality of the processing device of FIG. 6. Additionally, the temperature sensor 62 and/or the pressure sensor 64 of the FIG. 6 may be used in the apparatus 12 of FIG. 4 and/or the meter unit 42 of FIG. 5. In this way, the measurement error of FIGS. 4 and 5 may compensate for temperature and/or pressure as described above.

Although the invention has been described above with reference to one or more embodiments, it will be appreciated that various changes or modifications may be made without departing from the scope of the invention as defined in the appended claims.

1. An apparatus for determining a measurement error of a displacement volumetric meter, the meter having bellows which in use expand and contract to transmit a fluid, the apparatus comprising:
a transducer configured to detect movement of the bellows and to generate a signal which varies in accordance with the movement of the bellows; and
a computing device in communication with the transducer so as to receive the signal therefrom, the computing device being configured to determine a flow rate of fluid through the meter based on the signal, and to determine a measurement error of the meter based on the determined flow rate.

2. The apparatus of claim 1, wherein the transducer is a mechanical switch positioned inside a housing of the meter so that the switch is activated by the movement of the bellows.

3. The apparatus of claim 1, wherein the transducer is a vibration sensor configured to detect vibrations generated by the movement of the bellows, and wherein the signal varies in accordance with the detected vibrations.

4. The apparatus of claim 1, wherein the computing device is configured to identify a rate of expansion and contraction of the bellows from a variation of the signal, and determine the flow rate from a predetermined meter volume and the identified rate of expansion and contraction.

5. The apparatus of claim 3, wherein the computing device comprises a storage device containing a plurality of stored vibration signals each stored with an associated flow rate, and wherein the computing device is configured to: (i) compare the signal with the plurality of stored vibration signals to identify a matching stored vibration signal, and (ii) determine the flow rate from the associated flow rate stored with the matching stored vibration signal.

6. The apparatus of claim 5, further comprising:
a meter unit comprising the transducer and a transmitter, the transmitter being in communication with the transducer so as to receive the signal therefrom, the transmitter being configured to transmit the signal; and
wherein the computing'device is in communication with the transmitter via a communication channel so as to receive the signal therefrom.

7. The apparatus of claim 6, wherein the meter unit comprises a processing device coupled between the transducer and the transmitter, the processing device being configured to process the signal before transmission.

8. The apparatus of claim 7, wherein the processing device is configured to encrypt the signal, and wherein the computing device is configured to decrypt the encrypted signal.

9. The apparatus of claim 7, wherein the processing device is configured to digitize the signal.

10. The apparatus of claim 7, wherein the processing device is configured to generate a frequency domain representation of the signal and to remove frequencies of the signal which are outside a predetermined frequency range.

11. The apparatus of claim 7, wherein the meter unit comprises a temperature and/or pressure sensor coupled to the processing device, the temperature and/or pressure sensor being configured to generate temperature and/or pressure information which varies in accordance with a temperature and/or pressure at the meter unit;
wherein the processing device is configured to package the temperature and/or pressure information with the signal, and
wherein the computing device is configured store a plurality of temperature and/or pressure information, each stored temperature and/or pressure information being stored with an associated compensation factor, the computing device being further configured to: (i) identify the temperature and/or pressure information in the received signal, (ii) to compare the identified temperature and/or pressure information with the plurality of temperature and/or pressure information to identify a matching stored temperature and/or pressure information, and (iii) update the measurement error based on the associated compensation factor stored with the matching stored temperature and/or pressure information.

12. The apparatus of claim 5, wherein at least one stored vibration signal is stored with associated further meter information; and
wherein the computing device is configured to determine further meter information of the meter based on associated further meter information stored with the matching stored vibration signal.

13. The apparatus of claim 12, wherein the further meter information includes one or more of: meter type, meter model, meter age, meter reading, and meter fault.

14. The apparatus of claim 6, wherein the vibration sensor is a microphone and the vibration signal is an audio signal.

15. The apparatus of claim 14, wherein the computing device has a voice or music recognition module configured to identify the matching stored vibration signal using the signal and the plurality of stored vibration signals.

16. The apparatus of claim 14, wherein the microphone is configured to detect ambient noise and the signal includes a representation of the ambient noise, and
wherein the computing device is configured to: (i) determine the ambient noise from the signal, and (ii) identify a change in location of the meter based on a comparison between the determined ambient noise and previously received ambient noise.

17. The apparatus of claim 6, wherein the meter unit further comprises an attachment mechanism configured in use to fix the meter unit to the meter such that the vibration sensor is positioned to detect the vibrations generated by the movement of the bellows.

18. The apparatus of claim 17, wherein the attachment mechanism comprises a magnet.

19. A method of determining a measurement error of a displacement volumetric meter, the meter having bellows which in use expand and contract to transmit a fluid, the method comprising:
a. detecting movement of the bellows of the meter;
b. determining a flow rate of fluid through the meter based on the movement of the bellows; and
c. determining a measurement error of the meter based on the determined flow rate.

20. The method of claim 19, wherein the movement of the bellows is detected mechanically.

21. The method of claim 19, wherein the movement of the bellows is detected by detecting vibrations generated by the movement of the bellows.

22. The method of claim 19, wherein step b. comprises:
identifying a rate of expansion and contraction of the bellows from the detected movement of the bellows; and
determining the flow rate from a predetermined meter volume and the identified rate of expansion and contraction of the bellows.

23. The method of claim 21, wherein step b. comprises:
storing a plurality of vibration signals, each stored vibration signal being stored with an associated flow rate;
generating a vibration signal which varies in accordance with the detected vibrations;
comparing the generated vibration signal with the plurality of vibration signals to identify a matching stored vibration signal; and
determining the flow rate from the associated flow rate stored with the matching stored vibration signal.

24. The method of claim 23, further comprising: processing the generated vibration signal before comparing the generated vibration signal with the plurality of vibration signals.

25. The method of claim 24, wherein processing the generated vibration signal comprises: digitizing the generated vibration signal.

26. The method of claim 24, wherein processing the generated vibration signal comprises:
generating a frequency domain representation of the generated vibration signal, and
discarding frequencies of the generated vibration signal which are outside a predetermined frequency range.

27. The method of claim 23, wherein at least one stored vibration signal is stored with associated further meter information, and the method further comprises:
determining further meter information of the meter based on associated further meter information stored with the matching stored vibration signal.

28. The method of claim 27, wherein the further meter information includes:
meter type, meter model, meter age, meter reading, meter fault.

29. The method of claim 23, wherein the vibration signals are audio signals.

30. The method of claim 29, wherein the matching stored vibration signal is identified using a voice or music recognition algorithm.

31. The method of claim 29, wherein the generated vibration signal varies in accordance with ambient noise at the meter, and the method further comprises:
determining the ambient noise from the generated vibration signal; and
comparing the determined ambient noise with a previously recorded ambient noise to identify a change in location of the meter.

32. The method of claim 19, further comprising:
storing a plurality of temperature and/or pressure information, each stored temperature and/or pressure information being stored with an associated compensation factor;
generating temperature and/or pressure information which varies in accordance with a temperature and/or pressure at the meter;
comparing the generated temperature and/or pressure information with the plurality of temperature and/or pressure information to identify a matching stored temperature and/or pressure information; and
updating the measurement error based on the associated compensation factor stored with the matching stored temperature and/or pressure information.

33. A meter monitoring device for a displacement volumetric meter, the meter having bellows which in use expand and contract to transmit a fluid, the device comprising:
a transducer configured to detect movement of the bellows and to generate a signal which varies in accordance with the movement of the bellows; and
a transmitter in communication with the transducer so as to receive the signal therefrom, the transmitter being configured to transmit the signal.

34. The device of claim 33, wherein the transducer is a mechanical switch positioned inside a housing of the meter so that the switch is activated by the movement of the bellows.

35. The device of claim 33, wherein the transducer is a vibration sensor configured to detect vibrations generated by the movement of the bellows, and wherein the signal varies in accordance with the detected vibrations.

36. The device of claim 35, wherein the vibration sensor is a microphone and the vibration signal is an audio signal.

37. The device of claim 33, further comprising a processing device coupled between the transducer and the transmitter, the processing device being configured to process the signal before transmission.

38. The device of claim 37, wherein the processing device is configured to generate a frequency domain representation of the signal and to remove frequencies of the signal which are outside a predetermined frequency range.

39. The device of claim 37, further comprising a temperature and/or pressure sensor coupled to the processing device, the temperature and/or pressure sensor being configured to generate temperature and/or pressure information which varies in accordance with a temperature and/or pressure at the meter monitoring device, and wherein the processing device is configured to package the temperature and/or pressure information with the signal.

40. A meter measurement error determining device for a displacement volumetric meter, the meter having bellows which in use expand and contract to transmit a fluid, the device comprising:
at least one processor and at least one memory storing computer executable code which when executed by the at least one processor causes the device to:
receive a signal which varies in accordance with movement of the bellows of the meter;
determine a flow rate of fluid through the meter based on the received signal; and
determine a measurement error of the meter based on the determined flow rate.

41. The device of claim 40, wherein the computer executable code, when executed by the at least one processor, further causes the device to:
identify a rate of expansion and contraction of the bellows of the meter from a variation of the received signal; and
determine the flow rate from a predetermined meter volume and the identified rate of expansion and contraction.

42. The device of claim 40, wherein the computer executable code, when executed by the at least one processor, further causes the device to:
store, on the at least one memory, a plurality of stored vibration signals each stored with an associated flow rate;
compare the received signal with the plurality of stored vibration signals to identify a matching stored vibration signal; and
determine the flow rate from the associated flow rate stored with the matching stored vibration signal.

43. The device of claim 42, wherein the computer executable code, when executed by the at least one processor, further causes the device to:
store at least one stored vibration signal with associated further meter information; and
determine further meter information of the meter based on associated further meter information stored with the matching stored vibration signal.

44. The device of claim 43, wherein the further meter information includes: meter type, meter model, meter age, meter reading, meter fault.

45. The device of claim 42, wherein a voice or music recognition algorithm is used to identify the matching stored vibration signal from the signal and the plurality of stored vibration signals.

46. The device of claim 40, wherein the received signal comprises temperature and/or pressure information, and wherein the computer executable code, when executed by the at least one processor, further causes the device to:
store, on the at least one memory, a plurality of temperature and/or pressure information, each stored temperature and/or pressure information being stored with an associated compensation factor;
identify the temperature and/or pressure information in the received signal;
compare the identified temperature and/or pressure information with the plurality of temperature and/or pressure information to identify a matching stored temperature and/or pressure information; and
update the measurement error based on the associated compensation factor stored with the matching stored temperature and/or pressure information.
